(19) United States
(12) Patent Application Publication
(10) Pub. No.: US 2025/0103115 A1
(43) Pub. Date: Mar. 27, 2025

(54) COMMUNICATION SYSTEM AND POWER SUPPLY SWITCHING DEVICE

(71) Applicant: DENSO CORPORATION, Kariya-city (JP)

(72) Inventors: Ryota KAMEOKA, Kariya-city (JP); Tomohisa KISHIGAMI, Kariya-city (JP); Tomoya TOKUNAGA, Kariya-city (JP); Akira TADA, Kariya-city (JP)

(21) Appl. No.: 18/895,461

(22) Filed: Sep. 25, 2024

(30) Foreign Application Priority Data
Sep. 27, 2023 (JP) 2023-166036
Aug. 13, 2024 (JP) 2024-134990

(51) Int. Cl. G06F 1/26; H02J 1/08

(52) U.S. Cl. CPC G06F 1/26; H02J 1/084

(57) ABSTRACT

A communication system includes a slave control device that receives a power supply from a power source via a first power supply switching section, a first power supply switching control section configured to receive a power supply from the power source via a second power supply switching section and control an operation of the first power supply switching section, a second power supply switching control section configured to control an operation of the second power supply switching section, a switching transmission section configured to transmit first switching instruction information indicating whether to bring the first power supply switching section into the first conduction state to the first power supply switching control section; and a power supply control section configured to bring the second power supply switching section into either the second conduction state or the second cutoff state based on the management frame.

### CROSS REFERENCE TO RELATED APPLICATION

This application is based on Japanese Patent Application No. 2023-166036 filed on Sep. 27, 2023 and Japanese Patent Application No. 2024-134990 filed on Aug. 13, 2024, the disclosures of which are incorporated herein by reference.

### TECHNICAL FIELD

The present disclosure relates to a communication system including a plurality of control devices and a power supply switching device.

### BACKGROUND

A related art describes an in-vehicle network system that includes a power supply relay that individually switches on/off of a power source of an electronic control device for each of a plurality of electronic control devices, determines a control content for switching on/off of the power source of a specific electronic control device for the specific electronic control device corresponding to a scene identified based on a situation of a vehicle, and switches on/off of the power source supplied to the specific electronic control device using the power supply relay based on the determined control content.

### SUMMARY

A communication system includes a slave control device that receives a power supply from a power source via a first power supply switching section, a first power supply switching control section configured to receive a power supply from the power source via a second power supply switching section and control an operation of the first power supply switching section, a second power supply switching control section configured to control an operation of the second power supply switching section, a switching transmission section configured to transmit first switching instruction information indicating whether to bring the first power supply switching section into the first conduction state to the first power supply switching control section; and a power supply control section configured to bring the second power supply switching section into either the second conduction state or the second cutoff state based on the management frame.

### BRIEF DESCRIPTION OF DRAWINGS

FIG. 1 is a block diagram illustrating a configuration of a communication system according to the first embodiment.

FIG. 2 is a diagram illustrating a configuration of an NM frame and a relay management table.

FIG. 3 is a flowchart illustrating a master power supply management process according to the first embodiment.

FIG. 4 is a flowchart illustrating a slave power supply management process according to the first embodiment.

FIG. 5 is a block diagram illustrating a configuration of a communication system according to the second embodiment.

FIG. 6 is a flowchart illustrating a master power supply management process according to the second embodiment.

FIG. 7 is a flowchart illustrating a slave power supply management process according to the second embodiment.

FIG. 8 is a block diagram illustrating a configuration of a communication system according to the third embodiment.

FIG. 9 is a diagram illustrating a correspondence relationship between control targets and clusters.

FIG. 10 is a block diagram illustrating a configuration of a communication system according to the fourth embodiment.

FIG. 11 is a block diagram illustrating a configuration of a central ECU and an upstream power distribution section according to the fourth embodiment.

FIG. 12 is a first block diagram illustrating a configuration of a zone ECU according to the fourth embodiment.

FIG. 13 is a second block diagram illustrating a configuration of a zone ECU according to the fourth embodiment.

FIG. 14 is a block diagram illustrating a configuration of a slave ECU according to the fourth embodiment.

### DETAILED DESCRIPTION

As a result of detailed studies by the inventors, the following problems have been found. In the in-vehicle network system described in a related art, all the control devices (hereinafter, a first dependent control device) connected to the management control device receive a power supply from the power source via the power supply relay. However, in the technique described in a related art, in a case where there is a control device (hereinafter, a second dependent control device) further connected to the first dependent control device, the activation of the first dependent control device and the activation of the second dependent control device cannot be managed individually.

The present disclosure provides a technique to individually manage activation of a plurality of control devices in a communication system.

According to one aspect of the present disclosure, a communication system includes: a slave control device that receives a power supply from a power source via a first power supply switching section configured to switch between a first conduction state in which a first power supply path is conducted and a first cutoff state in which the first power supply path is cut off; a first power supply switching control section configured to receive a power supply from the power source via a second power supply switching section configured to switch between a second conduction state in which a second power supply path is conducted and a second cutoff state in which the second power supply path is cut off, and control an operation of the first power supply switching section; a second power supply switching control section configured to control an operation of the second power supply switching section; a switching transmission section configured to transmit, based on a management frame that is a communication frame including first switching information indicating whether to bring the first power supply switching section into the first conduction state and second switching information indicating whether to bring the second power supply switching section into the second conduction state, first switching instruction information indicating whether to bring the first power supply switching section into the first conduction state to the first power supply switching control section; and a power supply control section configured to bring the second power supply switching section into either the second conduction state or the second cutoff state based on the management frame.

Another aspect of the present disclosure is a power supply switching device configured to control the operation of a second power supply switching section in a communication system including a slave control device and a power supply switching control section.

The power supply switching device of the present disclosure includes a switching transmission section and a power supply control section. The power supply switching device of the present disclosure configured as described above is a device included in the communication system of the present disclosure and can achieve the same effects as the communication system of the present disclosure.

### First Embodiment

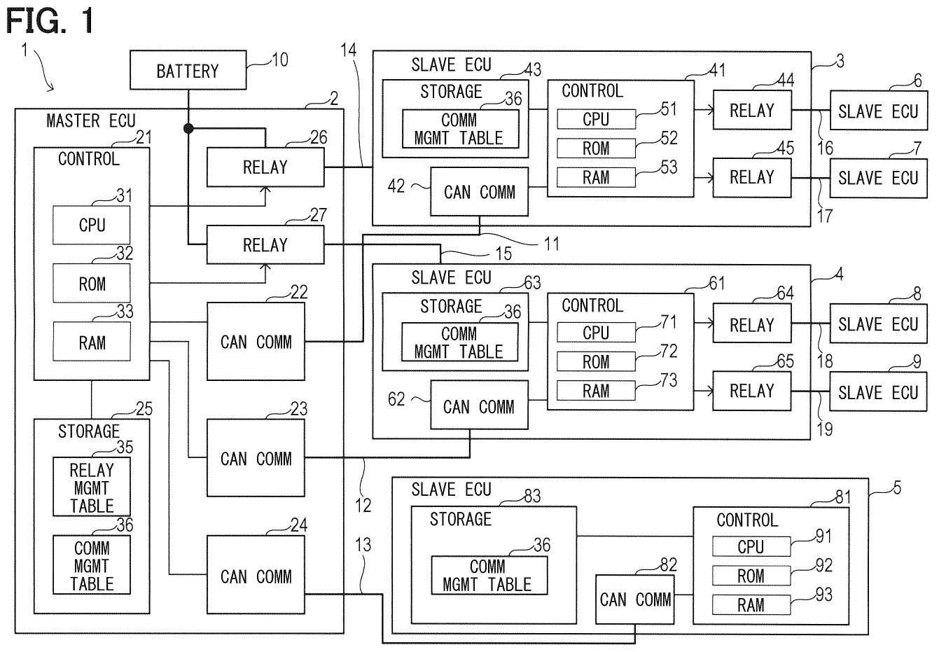

Hereinafter, the first embodiment of the present disclosure will be described with reference to the drawings. The communication system 1 of the present embodiment is mounted on a vehicle and includes a master ECU 2, slave ECUs 3, 4, 5, 6, 7, 8, and 9, and a battery 10 as illustrated in FIG. 1. ECU stands for Electronic Control Unit.

The master ECU 2 and the slave ECU 3 are data-communicably connected to each other via a communication bus 11. The master ECU 2 and the slave ECU 4 are data-communicably connected to each other via a communication bus 12.

The master ECU 2 and the slave ECU 5 are data-communicably connected to each other via a communication bus 13. The battery 10 supplies power to each section of the vehicle with a direct-current battery voltage (for example, 12 V). The master ECU 2 and the slave ECUs 3 to 9 operate by receiving a power supply from the battery 10.

The master ECU 2 includes a control section 21, CAN communication sections 22, 23, and 24, a storage section 25, and relays 26 and 27. CAN stands for Controller Area Network. The communication protocol of the communication system 1 is not limited to the CAN.

The control section 21 is an electronic control device mainly including a microcomputer including a CPU 31, a ROM 32, a RAM 33, and the like. Various functions of the microcomputer are implemented by the CPU 31 executing a program stored in a non-transitory tangible recording medium. In this example, the ROM 32 corresponds to a non-transitory tangible recording medium storing a program. Further, by executing this program, a method corresponding to the program is executed. Some or all of the functions executed by the CPU 31 may be configured as hardware by one or a plurality of ICs or the like. Furthermore, the number of microcomputers constituting the control section 21 may be one or more.

The CAN communication sections 22, 23, and 24 perform communication with the slave ECUs 3, 4, and 5 connected to the communication buses 11, 12, and 13, respectively, by transmitting and receiving a communication frame based on the CAN communication protocol.

The storage section 25 is a storage device for storing various pieces of data. The storage section 25 stores a relay management table 35 and a communication management table 36 to be described later. The relay 26 is disposed on a power supply path 14 between the battery 10 and the slave ECU 3. The relay 27 is disposed on a power supply path 15 between the battery 10 and the slave ECU 4.

The relay 26 is configured to switch between a conduction state in which the power supply path 14 is conducted and a cutoff state in which the power supply path 14 is cut off in accordance with a command from the control section 21. The relay 27 is configured to switch between a conduction state in which the power supply path 15 is conducted and a cutoff state in which the power supply path 15 is cut off in accordance with a command from the control section 21. Hereinafter, the conduction state is also referred to as an on state, and the cutoff state is also referred to as an off state.

The slave ECU 3 includes a control section 41, a CAN communication section 42, a storage section 43, and relays 44 and 45. The control section 41 is an electronic control device mainly including a microcomputer including a CPU 51, a ROM 52, a RAM 53, and the like. Various functions of the microcomputer are implemented by the CPU 51 executing a program stored in a non-transitory tangible recording medium. In this example, the ROM 52 corresponds to a non-transitory tangible recording medium storing a program. Further, by executing this program, a method corresponding to the program is executed. Some or all of the functions executed by the CPU 51 may be configured as hardware by one or a plurality of ICs or the like. Furthermore, the number of microcomputers constituting the control section 41 may be one or more.

The CAN communication section 42 is connected to the CAN communication section 22 via the communication bus 11, and performs communication with the master ECU 2 based on the CAN communication protocol. The storage section 43 is a storage device for storing various pieces of data. The storage section 43 stores a communication management table 36 to be described later.

The relay 44 is disposed on a power supply path 16 between the slave ECU 3 and the slave ECU 6. The power supply path 16 is connected to the battery 10 via the power supply path 14. The relay 45 is disposed on a power supply path 17 between the slave ECU 3 and the slave ECU 7. The power supply path 17 is connected to the battery 10 via the power supply path 14.

The slave ECU 4 includes a control section 61, a CAN communication section 62, a storage section 63, and relays 64 and 65. The control section 61 is an electronic control device mainly including a microcomputer including a CPU 71, a ROM 72, a RAM 73, and the like. Various functions of the microcomputer are implemented by the CPU 71 executing a program stored in a non-transitory tangible recording medium. In this example, the ROM 72 corresponds to a non-transitory tangible recording medium storing a program. Further, by executing this program, a method corresponding to the program is executed. Some or all of the functions executed by the CPU 71 may be configured as hardware by one or a plurality of ICs or the like. Furthermore, the number of microcomputers constituting the control section 61 may be one or more.

The CAN communication section 62 is connected to the CAN communication section 23 via the communication bus 12, and performs communication with the master ECU 2 based on the CAN communication protocol. The storage section 63 is a storage device for storing various pieces of data. The storage section 63 stores a communication management table 36 to be described

The relay 64 is disposed on a power supply path 18 between the slave ECU 4 and the slave ECU 8. The power supply path 18 is connected to the battery 10 via the power supply path 15. The relay 65 is disposed on a power supply path 19 between the slave ECU 4 and the slave ECU 9. The power supply path 19 is connected to the battery 10 via the power supply path 15.

The slave ECU 5 includes a control section 81, a CAN communication section 82, and a storage section 83. The control section 81 is an electronic control device mainly including a microcomputer including a CPU 91, a ROM 92, a RAM 93, and the like. Various functions of the microcomputer are implemented by the CPU 91 executing a program stored in a non-transitory tangible recording medium. In this example, the ROM 92 corresponds to a non-transitory tangible recording medium storing a program. Further, by executing this program, a method corresponding to the program is executed. Some or all of the functions executed by the CPU 91 may be configured as hardware by one or a plurality of ICs or the like. Furthermore, the number of microcomputers constituting the control section 81 may be one or more.

The CAN communication section 82 is connected to the CAN communication section 24 via the communication bus 13, and performs communication with the master ECU 2 based on the CAN communication protocol. The storage section 83 is a storage device for storing various pieces of data. The storage section 83 stores a communication management table 36 to be described later.

The CAN frame includes a start of frame, an arbitration field, a control field, a data field, a CRC field, an ACK field, and an end of frame. The arbitration field includes an 11-bit or 29-bit identifier (that is, ID) and a 1-bit RTR bit.

An 11-bit identifier used in CAN communication is referred to as a CAN ID. The CAN ID is preset based on the content of data included in the CAN frame, a transmission source of the CAN frame, a transmission destination of the CAN frame, and the like.

The data field is a payload including first data, second data, third data, fourth data, fifth data, sixth data, seventh data, and eighth data each of which has 8 bits (that is, one byte).

The master ECU 2 and the slave ECUs 3 to 9 are configured to switch between a wake-up state (that is, the activation state) and a sleep state (that is, the dormancy state). The wake-up state is a normal operation state in which a function assigned to the ECU can be used without restriction. The sleep state is a low power consumption operation state in which available functions are restricted.

In the communication system 1, an NM frame, which is a CAN frame including switching information, is used to switch the relays 26, 27, 44, 45, 64, and 65 to an on state or an off state. NM stands for Network Management.

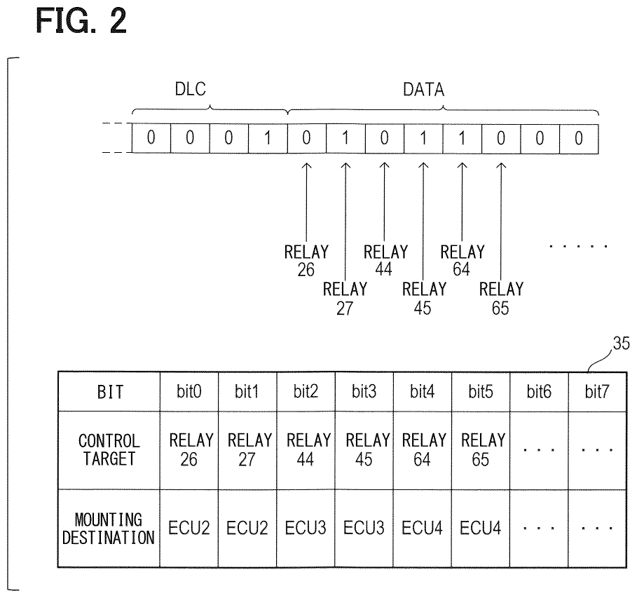

The switching information is set as illustrated in FIG. 2, for example. DLC stands for Data Length Code, and is a region representing a size of a data field in a CAN frame in byte units. That is, the switching information is stored in the data field of the CAN frame. Here, in order to simplify the description, a case where DLC is 1 byte (that is, 8 bits) will be described.

The switching information of the relay 26, the switching information of the relay 27, the switching information of the relay 44, the switching information of the relay 45, the switching information of the relay 64, and the switching information of the relay 65 are allocated to respective bits of the 8-bit data.

In the NM frame illustrated in FIG. 2, the switching information of the relay 26 is allocated to the first highest bit of the first data, the switching information of the relay 27 is allocated to the second highest bit of the first data, the switching information of the relay 44 is allocated to the third highest bit of the first data, the switching information of the relay 45 is allocated to the fourth highest bit of the first data, the switching information of the relay 64 is allocated to the fifth highest bit of the first data, and the switching information of the relay 65 is allocated to the sixth highest bit of the first data.

Then, in the NM frame illustrated in FIG. 2, for example, 0 is set to the first highest bit of the first data, and thus, the NM frame illustrated in FIG. 2 instructs the relay 26 to be turned off.

In addition, in the NM frame illustrated in FIG. 2, 1 is set in the second highest bit of the first data, and thus, the NM frame illustrated in FIG. 2 instructs the relay 27 to be turned on. As illustrated in FIG. 2, the relay management table 35 sets, for each of a plurality of pieces of switching information included in an NM frame, a correspondence relationship between switching information, and a control target and a mounting destination.

The relay management table 35 illustrated in FIG. 2 indicates that the switching information of the first highest bit (that is, bit0 in FIG. 2) of the first data targets the relay 26 for control and the control target (that is, the relay 26) is to be mounted on the master ECU 2.

Similarly, the relay management table 35 indicates that the switching information of the second highest bit (that is, bit1 in FIG. 2) of the first data targets the relay 27 for control and the control target (that is, the relay 27) is to be mounted on the master ECU 2.

The relay management table 35 indicates that the switching information of the third highest bit (that is, bit2 in FIG. 2) of the first data targets the relay 44 for control and the control target (that is, the relay 44) is to be mounted on the slave ECU 3.

The relay management table 35 indicates that the switching information of the fourth highest bit (that is, bit3 in FIG. 2) of the first data targets the relay 45 for control and the control target (that is, the relay 45) is to be mounted on the slave ECU 3.

The relay management table 35 also indicates that the switching information of the fourth highest bit (that is, bit3 in FIG. 2) of the first data targets the relay 45 for control and the control target (that is, the relay 45) is to be mounted on the slave ECU 3.

The relay management table 35 also indicates that the switching information of the fifth highest bit (that is, bit4 in FIG. 2) of the first data targets the relay 64 for control and the control target (that is, the relay 64) is to be mounted on the slave ECU 4.

The relay management table 35 also indicates that the switching information of the sixth highest bit (that is, bit5 in FIG. 2) of the first data targets the relay 65 for control and the control target (that is, the relay 65) is to be mounted on the slave ECU 4.

The communication management table 36 illustrated in FIG. 1 sets a correspondence relationship between a service and switching information for each of a plurality of services provided to an occupant of a vehicle using the master ECU 2 and the slave ECUs 3 to 9.

The communication management table 36 specifies, for example, for the first service, that the relay 26 is turned on as the switching information of the relay 26, that the relay 27 is turned off as the switching information of the relay 27, that the relay 44 is turned on as the switching information of the relay 44, that the relay 45 is turned off as the switching information of the relay 45, that the relay 64 is turned off as the switching information of the relay 64, and that the relay 65 is turned off as the switching information of the relay 65.

The communication management table 36 specifies, for example, for the second service, that the relay 26 is turned off as the switching information of the relay 26, that the relay 27 is turned on as the switching information of the relay 27, that the relay 44 is turned off as the switching information of the relay 44, that the relay 45 is turned off as the switching information of the relay 45, that the relay 64 is turned on as the switching information of the relay 64, and that the relay 65 is turned on as the switching information of the relay 65.

Therefore, when detecting that a service start condition is satisfied, the master ECU 2 and the slave ECUs 3 to 5 extract switching information corresponding to the corresponding service from the communication management table 36, and generate and transmit an NM frame including the extracted switching information.

In a state where a plurality of NM frames corresponding to a plurality of services are being transmitted, the ECU on the receiving side of the NM frame turns on the relay with the OR (that is, logical sum) of the switching information and turns off the relay with the AND (that is, logical product) of the switching information. On the other hand, when the same ECU generates an NM frame corresponding to a plurality of services, the NM frame may be generated and transmitted as one NM frame corresponding to the plurality of services, with the switching information for turning on the relay being OR and the switching information for turning off the relay being AND.

Next, a procedure of the master power supply management process executed by the control section 21 of the master ECU 2 will be described. The master power supply management process is a process repeatedly executed during activation of the master ECU 2.

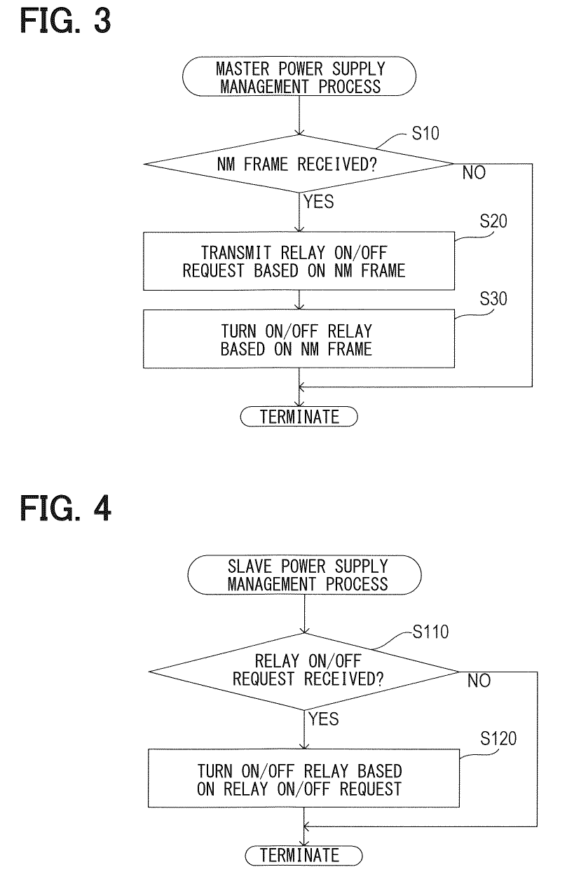

When the master power supply management process is executed, in S10, the CPU 31 of the control section 21 determines whether an NM frame has been received as illustrated in FIG. 3. Here, in a case where the NM frame has not been received, the CPU 31 terminates the master power supply management process. The master ECU 2 may also generate and transmit an NM frame, and in this case, the operation is the same as when the NM frame is received.

On the other hand, in a case where the NM frame is received, in S20, the CPU 31 transmits a relay on/off request to the slave ECUs 3 and 4 based on the switching information included in the received NM frame and the relay management table 35.

Specifically, the CPU 31 first refers to the relay management table 35 to identify the bit and the control target where the slave ECUs 3 and 4 are mounting destinations. Further, the CPU 31 identifies whether to turn on the relay to be controlled based on the switching information of the identified bit in the received NM frame. Then, the CPU 31 transmits a relay on/off request indicating whether to turn on the identified control target to the identified mounting destination. However, in a case of turning off the relay connected to the identified mounting destination and mounted on the master ECU 2, the CPU 31 does not transmit the relay on/off request to the identified mounting destination.

For example, in the relay management table 35 illustrated in FIG. 2, the bits where the slave ECU 3 is a mounting destination are the third highest bit (that is, bit2 in FIG. 2) and the fourth highest bit (that is, bit3 in FIG. 2). In addition, the control target of the third highest bit is the relay 44, and the control target of the fourth highest bit is the relay 45. Then, in the NM frame illustrated in FIG. 2, the third highest bit is 0, and the fourth highest bit is 1.

Therefore, the CPU 31 transmits, to the slave ECU 3, a relay on/off request indicating to turn off the relay 44 and a relay on/off request indicating to turn on the relay 45.

However, in a case where the relay 26 connected to the slave ECU 3 and mounted in the master ECU 2 is turned off (that is, in a case where the first highest bit in the NM frame is 0), the CPU 31 does not transmit the relay on/off request to the slave ECU 3.

In S30, the CPU 31 turns on or off the relays 26 and 27 based on the switching information included in the received NM frame and the relay management table 35, and terminates the master power supply management process.

Specifically, the CPU 31 first refers to the relay management table 35 to identify the bit and the control target where the master ECU 2 is a mounting destination. Further, the CPU 31 identifies whether to turn on the relay to be controlled based on the switching information of the identified bit in the received NM frame. Then, the CPU 31 turns on or off the relay to be controlled based on the identified result.

For example, in the relay management table 35 illustrated in FIG. 2, the bits where the master ECU 2 is a mounting destination are the first highest bit (that is, bit0 in FIG. 2) and the second highest bit (that is, bit1 in FIG. 2). In addition, the control target of the first highest bit is the relay 26, and the control target of the second highest bit is the relay 27. Then, in the NM frame illustrated in FIG. 2, the first highest bit is 0, and the second highest bit is 1.

Therefore, the CPU 31 turns off the relay 26 and turns on the relay 27. Next, a procedure of the slave power supply management process executed by the control sections 41 and 61 of the slave ECUs 3 and 4 will be described. The slave power supply management process is a process repeatedly executed during activation of the slave ECUs 3 and 4.

When the slave power supply management process is executed, in S110, the CPUs 51 and 71 of the control sections 41 and 61 determine whether a relay on/off request has been received as illustrated in FIG. 4. Here, in a case where the relay on/off request has not been received, the CPUs 51 and 71 terminate the slave power supply management process.

On the other hand, in a case where the relay on/off request has been received, in S120, the CPUs 51 and 71 turn on or off the relay mounted on the subject device based on the received relay on/off request, and terminate the slave power supply management process. The relays mounted on the slave ECU 3 are relays 44 and 45. The relays mounted on the slave ECU 4 are relays 64 and 65.

The communication system 1 configured as described above includes the slave ECU 6, the slave ECU 3, and the master ECU 2. The slave ECU 6 receives a power supply from the battery 10 via the relay 44 configured to switch between a conduction state (hereinafter, the first conduction state) in which the power supply path 16 is conducted and a cutoff state (hereinafter, the first cutoff state) in which the power supply path 16 is cut off.

The slave ECU 3 is configured to receive a power supply from the battery 10 via the relay 26 configured to switch between a conduction state (hereinafter, the second conduction state) in which the power supply path 14 is conducted and a cutoff state (hereinafter, the second cutoff state) in which the power supply path 14 is cut off, and control the operation of the relay 44.

The master ECU 2 is configured to control the operation of the relay 26. The master ECU 2 is configured to transmit a relay on/off request for requesting whether to bring the relay 44 into the first conduction state to the slave ECU 3 based on switching information (hereinafter, first switching information) indicating whether to bring the relay 44 into the first conduction state and switching information (hereinafter, second switching information) indicating whether to bring the relay 26 into the second conduction state included in an NM frame.

The master ECU 2 is configured to bring the relay 26 into either the second conduction state or the second cutoff state based on the NM frame. The master ECU 2 includes the relay management table 35. The relay management table 35 specifies mounting destination information (hereinafter, first mounting destination information) indicating the ECU on which the relay 44 is mounted and mounting destination information (hereinafter, second mounting destination information) indicating the ECU on which the relay 26 is mounted.

Upon receiving the NM frame that is a CAN frame including switching information (hereinafter, first switching information) indicating whether the relay 44 is to be brought into the first conduction state and switching information (hereinafter, second switching information) indicating whether the relay 26 is to be brought into the second conduction state, the master ECU 2 is configured to transmit a relay on/off request for requesting whether the relay 44 is to be brought into the first conduction state to the slave ECU 3 based on the first mounting destination information of the relay management table 35 and the first switching information.

Upon receiving the NM frame, the master ECU 2 brings the relay 26 into either the second conduction state or the second cutoff state based on the second mounting destination information of the relay management table 35 and the second switching information.

In such a communication system 1, the master ECU 2 can bring the relay 26 into either the second conduction state or the second cutoff state based on the second switching information included in the NM frame. Further, in the communication system 1, the slave ECU 3 can bring the relay 44 into either the first conduction state or the first cutoff state based on the relay on/off request transmitted from the master ECU 2 based on the first switching information included in the NM frame. Therefore, the communication system 1 can individually control the power supply to the slave ECU 3 connected to the master ECU 2 and the power supply to the slave ECU 6 connected to the slave ECU 3, and can individually manage the activation of the plurality of slave ECUs 3 and 6.

The master ECU 2 is configured to prohibit transmission of the relay on/off request to the slave ECU 3 in a case where the second switching information included in the NM frame indicates the second cutoff state. Such a communication system 1 can suppress the occurrence of an event in which the master ECU 2 unnecessarily transmits a relay on/off request related to the slave ECU 6 to the slave ECU 3 although power is not supplied to the slave ECU 6 due to the relay 26 being in the second cutoff state, and can reduce the processing load of the master ECU 2.

In the embodiment described above, the power supply path 16 corresponds to a first power supply path, the relay 44 corresponds to a first power supply switching section, the battery 10 corresponds to a power source, and the slave ECU 6 corresponds to a slave control device.

The power supply path 14 corresponds to a second power supply path, the relay 26 corresponds to a second power supply switching section, the slave ECU 3 corresponds to a first power supply switching control section, and the master ECU 2 corresponds to a second power supply switching control section and a power supply switching device.

The relay management table 35 corresponds to a switching section management table, the NM frame corresponds to a management frame, the relay on/off request corresponds to first switching instruction information and a first switching request, S20 corresponds to the process as a switching transmission section, and S30 corresponds to the process as a power supply control section.

### Second Embodiment

Hereinafter, the second embodiment of the present disclosure will be described with reference to the drawings. In the second embodiment, components different from the first embodiment will be described. Common configurations are denoted by the same reference numerals.

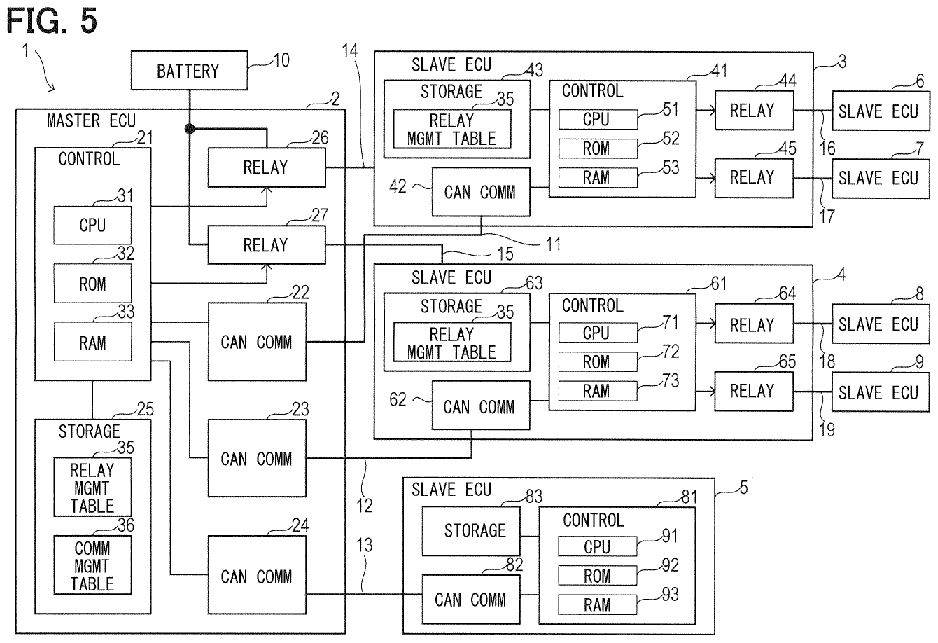

As illustrated in FIG. 5, the communication system 1 of the second embodiment is different from that of the first embodiment in that a relay management table 35 is stored in the storage section 43 of the slave ECU 3 and a relay management table 35 is stored in the storage section 63 of the slave ECU 4.

The communication system 1 of the second embodiment is different from that of the first embodiment in the procedure of the master power supply management process and the slave power supply management process. Next, a procedure of the master power supply management process according to the second embodiment will be described. The master power supply management process is a process repeatedly executed during activation of the master ECU 2.

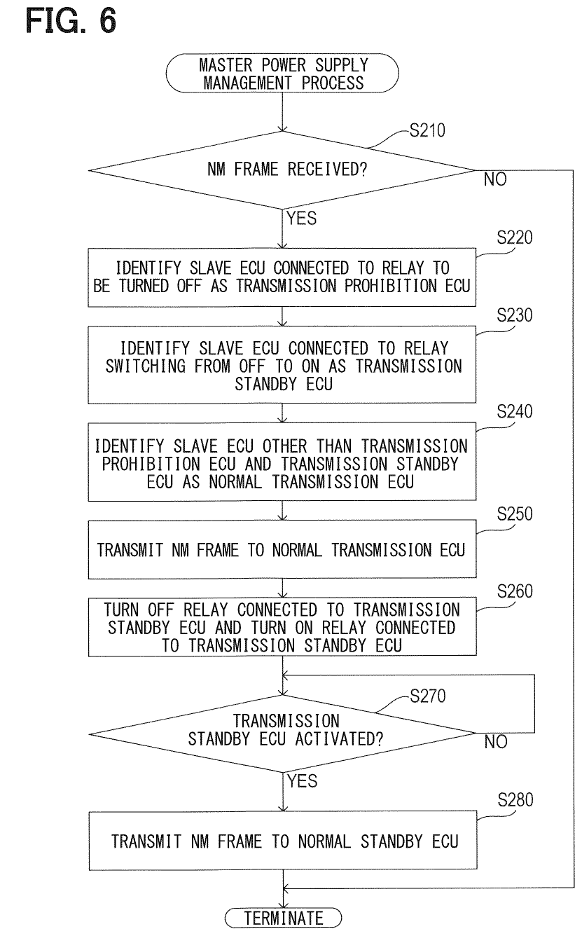

When the master power supply management process of the second embodiment is executed, in S210, the CPU 31 of the control section 21 determines whether an NM frame has been received as illustrated in FIG. 6. Here, in a case where the NM frame has not been received, the CPU 31 terminates the master power supply management process.

On the other hand, in a case where the NM frame is received, in S220, the CPU 31 identifies the slave ECUs 3 and 4 connected to the relays 26 and 27 to be turned off as transmission prohibition ECUs based on the switching information included in the received NM frame and the relay management table 35.

Specifically, the CPU 31 first refers to the relay management table 35 to recognize that the first highest bit of the first data targets the relay 26 (that is, the slave ECU 3) for control and the second highest bit of the first data targets the relay 27 (that is, the slave ECU 4) for control. In a case where the first highest bit of the first data is 0 in the received NM frame, the CPU 31 identifies the slave ECU 3 as the transmission prohibition ECU. In a case where the second highest bit of the first data is 0 in the received NM frame, the CPU 31 identifies the slave ECU 4 as the transmission prohibition ECU.

In S230, based on the switching information included in the NM frame received in S210, the switching information included in the NM frame received last time, and the relay management table 35, the CPU 31 identifies the slave ECUs 3 and 4 connected to the relays 26 and 27 that switch from the off state to the on state as transmission standby ECUs.

Specifically, the CPU 31 first refers to the relay management table 35 to recognize that the first highest bit of the first data targets the relay 26 (that is, the slave ECU 3) for control and the second highest bit of the first data targets the relay 27 (that is, the slave ECU 4) for control. The CPU 31 identifies the slave ECU 3 as the transmission standby ECU in a case where the first highest bit of the first data in the NM frame received last time is 0 and the first highest bit of the first data in the NM frame received in S210 is 1. Further, the CPU 31 identifies the slave ECU 4 as the transmission standby ECU in a case where the second highest bit of the first data in the NM frame received last time is 0 and the second highest bit of the first data in the NM frame received in S210 is 1.

In S240, the CPU 31 identifies, as the normal transmission ECU, an ECU that is not identified as the transmission prohibition ECU and is not identified as the transmission standby ECU, among the slave ECUs 3 and 4.

In S250, the CPU 31 transmits the NM frame received in S210 to a normal transmission ECU. In S260, the CPU 31 turns off the relay connected to the transmission prohibition ECU and turns on the relay connected to the transmission standby ECU. Specifically, the CPU 31 turns off the relay 26 in a case where the transmission prohibition ECU is the slave ECU 3, and turns off the relay 27 in a case where the transmission prohibition ECU is the slave ECU 4. The CPU 31 turns on the relay 26 in a case where the transmission standby ECU is the slave ECU 3, and turns on the relay 27 in a case where the transmission standby ECU is the slave ECU 4.

In S270, the CPU 31 determines whether the transmission standby ECU is activated. Specifically, in a case where an activation completion notification indicating that the activation is completed is received from the transmission standby ECU, the CPU 31 determines that the transmission standby ECU is activated.

Here, in a case where the transmission standby ECU is not activated, the CPU 31 repeats the process of S260 to wait until the transmission standby ECU is activated. Then, when the transmission standby ECU is activated, in S280, the CPU 31 transmits the NM frame received in S210 to the transmission standby ECU, and terminates the master power supply management process.

Next, a procedure of slave power supply management process according to the second embodiment will be described. The slave power supply management process of the second embodiment is a process repeatedly executed during activation of the slave ECUs 3 and 4.

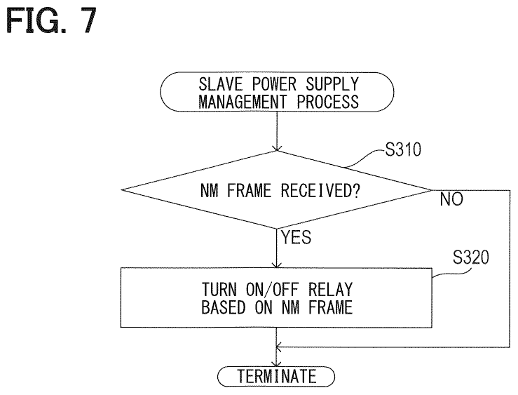

When the slave power supply management process of the second embodiment is executed, in S310, the CPUs 51 and 71 of the control sections 41 and 61 determine whether an NM frame has been received as illustrated in FIG. 7. Here, in a case where the NM frame has not been received, the CPUs 51 and 71 terminate the slave power supply management process.

On the other hand, in a case where the NM frame is received, the CPUs 51 and 71 turn on or off the relay mounted in the subject device based on the received NM frame in S320, and terminate the slave power supply management process.

Specifically, the CPUs 51 and 71 first refer to the relay management table 35 to identify the bit and the control target where the subject device is a mounting destination. Further, the CPUs 51 and 71 identify whether to turn on the relay to be controlled based on the switching information of the identified bit in the received NM frame. Then, the CPUs 51 and 71 turn on or off the relay to be controlled based on the identified result.

For example, in the relay management table 35 illustrated in FIG. 2, the bits where the slave ECU 3 is a mounting destination are the third highest bit (that is, bit2 in FIG. 2) and the fourth highest bit (that is, bit3 in FIG. 2). In addition, the control target of the third highest bit is the relay 44, and the control target of the fourth highest bit is the relay 45. Then, in the NM frame illustrated in FIG. 2, the third highest bit is 0, and the fourth highest bit is 1.

Therefore, the CPU 51 of the slave ECU 3 turns off the relay 44 and turns on the relay 45. The communication system 1 configured as described above includes the slave ECU 6, the slave ECU 3, and the master ECU 2.

The master ECU 2 is configured to transmit an NM frame to the slave ECU 3 when receiving the NM frame that is a CAN frame including first switching information indicating whether the relay 44 is brought into the first conduction state and second switching information indicating whether the relay 26 is brought into the second conduction state.

Upon receiving the NM frame, the master ECU 2 brings the relay 26 into either the second conduction state or the second cutoff state based on the second switching information included in the NM frame.

Upon receiving the NM frame, the slave ECU 3 brings the relay 44 into either the first conduction state or the first cutoff state based on the first switching information included in the NM frame.

In such a communication system 1, the master ECU 2 can bring the relay 26 into either the second conduction state or the second cutoff state based on the second switching information included in the NM frame. Further, in the communication system 1, the slave ECU 3 can bring the relay 44 into either the first conduction state or the first cutoff state based on the first switching information included in the NM frame. Therefore, the communication system 1 can individually control the power supply to the slave ECU 3 connected to the master ECU 2 and the power supply to the slave ECU 6 connected to the slave ECU 3, and can individually manage the activation of the plurality of slave ECUs 3 and 6.

The master ECU 2 is configured to prohibit the transmission of the NM frame in a case where the second switching information included in the NM frame indicates the second cutoff state. Such a communication system 1 can suppress the occurrence of an event in which the master ECU 2 unnecessarily transmits the NM frame to the slave ECU 3 although power is not supplied to the slave ECU 6 due to the relay 26 being in the second cutoff state, and can reduce the processing load of the master ECU 2.

In a case where the relay 26 is in the second cutoff state and the second switching information included in the NM frame indicates the second conduction state, the master ECU 2 is configured to transmit the NM frame after the relay 26 is in the second conduction state and the slave ECU 3 is activated. Such a communication system 1 can suppress the occurrence of an event in which the master ECU 2 unnecessarily transmits the NM frame to the slave ECU 3 although the slave ECU 3 is not activated, and can reduce the processing load of the master ECU 2.

In the embodiment described above, S250 and S280 correspond to the process as a switching transmission section, and S260 corresponds to the process as a power supply control section.

### Third Embodiment

Hereinafter, the third embodiment of the present disclosure will be described with reference to the drawings. In the third embodiment, components different from the first embodiment will be described. Common configurations are denoted by the same reference numerals.

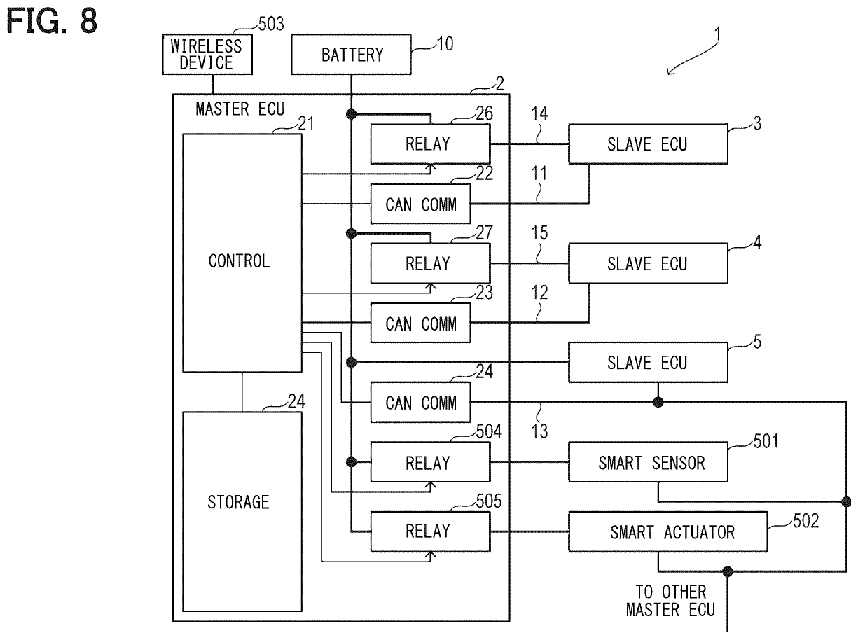

As illustrated in FIG. 8, the communication system 1 of the third embodiment is different from that of the first embodiment in that a smart sensor 501, a smart actuator 502, a wireless device 503, and relays 504 and 505 are added.

The smart sensor 501 is a sensor having a communication function. The smart sensor 501 is connected to the communication bus 13. The smart actuator 502 is an actuator having a communication function. The smart actuator 502 is connected to the communication bus 13.

The wireless device 503 is a wireless communication device for performing wireless communication with an external communication device installed outside the vehicle. The wireless device 503 is, for example, a DCM. DCM stands for Data Communication Module.

The relay 504 is disposed on a power supply path between the battery 10 and the smart sensor 501. The relay 505 is disposed on a power supply path between the battery 10 and the smart actuator 502.

The relays 504 and 505 are each configured to switch between a conduction state in which the power supply path is conducted and a cutoff state in which the power supply path is cut off in accordance with a command from the control section 21. Hereinafter, the master ECU 2, the slave ECUs 3 to 5, the smart sensor 501, and the smart actuator 502 are collectively referred to as nodes.

### (Prerequisites)

The master ECU 2 and the slave ECU 5 are always powered from the battery 10 without passing through a relay, and can switch between the wake-up state and the sleep state independently. Hereinafter, the master ECU 2 and the slave ECU 5 are also referred to as NM-equipped nodes. An NM-equipped node is a node having a function of generating an NM frame.

The slave ECUs 3 and 4, the smart sensor 501, and the smart actuator 502 are powered via relays and cannot switch between the wake-up state and the sleep state independently. In other words, they enter the wake-up state when the relay is turned on and enter the sleep state when the relay is turned off. Hereinafter, the slave ECUs 3 and 4, the smart sensor 501, and the smart actuator 502 are also referred to as NM-non-equipped nodes. An NM-non-equipped node is a node that does not have a function of generating and interpreting an NM frame.

The NM-non-equipped nodes include at least one of an actuator and a sensor in addition to an ECU having a control function. The power supply paths of the NM-non-equipped nodes are connected to the relays 26, 27, 504, and 505 of the master ECU 2, respectively.

The NM-non-equipped nodes and the relays may be connected in a one-to-one relationship, or a plurality of NM-non-equipped nodes belonging to the same cluster (that is, a group that starts simultaneously) may be connected under one relay.

The master ECU 2 and the NM-equipped nodes have CAN communication sections and can transmit and receive NM frames. The NM-equipped nodes determine whether they are in the wake-up state or the sleep state based on the NM frames transmitted and received via the communication bus.

The master ECU 2 turns the relays 26, 27, 504, and 505 connected to the NM-non-equipped nodes on or off based on the NM frames transmitted and received via the communication bus.

The payload (that is, the data area) of the NM frames transmitted and received by the master ECU 2 and the NM-equipped nodes stores information indicating which cluster to activate in one or more bits.

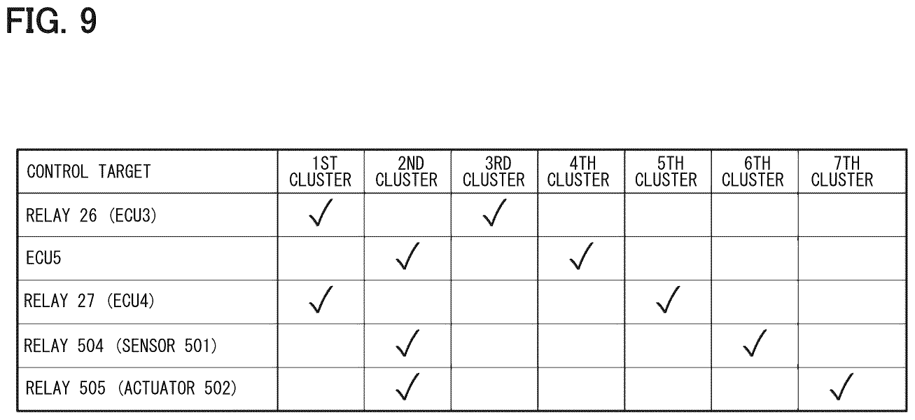

One or more master ECUs (that is, ECUs with built-in relays) are mounted on the vehicle. As illustrated in FIG. 9, one or more nodes belonging to each cluster are predetermined by the system developer. It is possible to assign a cluster to each node, but a plurality of nodes can be registered in one cluster. When the bit corresponding to each cluster is active (that is, bit=1), the cluster wakes up. In the case of the master ECU, wake-up means turning the relay on.

### First Activation Example

The first activation example is an operation example in which a failure diagnosis of the slave ECU 3 is performed based on a request from the cloud.

First, a connection request is sent from a base station (that is, the cloud) to the wireless device 503 of the vehicle. Next, when the wireless device 503 determines that the connection is valid, it notifies the master ECU 2 of the event received from the cloud.

Next, the master ECU 2 determines a service of “failure diagnosis of the slave ECU 3” based on the event and generates an NM frame in which the bit of the third cluster to which only the slave ECU 3 belongs is activated to activate the slave ECU 3.

Next, the master ECU 2 transmits the generated NM frame onto the communication buses 11, 12, and 13. Since there are no NM-equipped nodes belonging to the third cluster on the communication buses 11, 12, and 13, there is no change in the devices on the communication buses.

Next, the master ECU 2 simultaneously executes processing based on the NM frame in the control section 21 as if it had received the NM frame with the bit of the third cluster activated. When the control section 21 of the master ECU 2 determines a wake-up instruction for the third cluster based on the NM frame, it turns the relay 26 on since the relay 26 is included in the third cluster.

When the relay 26 is turned on, power is supplied to the downstream slave ECU 3, and the slave ECU 3 is activated. The master ECU 2 waits for the activation of the slave ECU 3, requests a diagnostic code from the slave ECU 3, and transmits the response result from the slave ECU 3 to the base station via the wireless device 503.

### Second Activation Example

The second activation example is an operation example in which a failure diagnosis of the slave ECU 5 is performed based on a request from the cloud.

First, a connection request is sent from a base station (that is, the cloud) to the wireless device 503 of the vehicle. Next, when the wireless device 503 determines that the connection is valid, it notifies the master ECU 2 of the event received from the cloud.

Next, the master ECU 2 determines a service of “failure diagnosis of the slave ECU 5” based on the event and generates an NM frame in which the bit of the fourth cluster to which only the slave ECU 5 belongs is activated to activate the slave ECU 5.

Next, the master ECU 2 transmits the generated NM frame onto the communication buses 11, 12, and 13. Since the slave ECU 5 is on the communication bus 13 as a node belonging to the fourth cluster, the slave ECU 5 wakes up.

Next, the master ECU 2 simultaneously executes processing based on the NM frame in the control section 21 as if it had received the NM frame with the bit of the fourth cluster activated. When the control section 21 of the master ECU 2 determines a wake-up instruction for the fourth cluster, it ignores it since there is no corresponding relay in the fourth cluster.

When the slave ECU 5 is activated, the master ECU 2 requests a diagnostic code from the slave ECU 5 via the communication bus 13 and transmits the response result from the slave ECU 5 to the base station via the wireless device 503.

### Third Activation Example

The third activation example is an operation example in which the user activates the remote air conditioning using a smartphone. First, the user instructs the in-vehicle air conditioner to turn on from the smartphone.

When the wireless device 503 receives the instruction signal from the smartphone and determines that the instruction signal is valid, it notifies the master ECU 2 of the event (that is, the instruction signal) received from the cloud.

The master ECU 2 determines an “air conditioning service” based on the event and generates an NM frame in which the second cluster is activated as the air conditioning cluster. The master ECU 2 periodically transmits the generated NM frame onto the communication buses 11, 12, and 13 until an air conditioner stop instruction is issued. To maintain the active state, the NM frame needs to be transmitted periodically. Simultaneously, the control section 21 of the master ECU 2 executes processing based on the NM frame.

When the NM frame with the second cluster activated appears on the communication bus 13, the slave ECU 5 (that is, the air conditioner ECU) belonging to the second cluster receives the NM frame and wakes up according to the received NM frame.

When the control section 21 of the master ECU 2 detects that the second cluster is active, it turns the relay 504 and the relay 505 belonging to the second cluster on. When the relay 504 and the relay 505 are turned on, power is supplied to the smart sensor 501 (that is, the temperature sensor) and the smart actuator 502 (that is, the compressor).

As a result, power supply to the air conditioner ECU, the smart sensor 501, and the smart actuator 502 starts, and it becomes possible to turn on the in-vehicle air conditioner. When the user instructs the in-vehicle air conditioner to turn off from the smartphone, the master ECU 2 stops the periodic transmission of the NM frame.

When the NM frame is interrupted, the slave ECU 5 transitions to the sleep state, and the master ECU 2 turns off the relay 504 and the relay 505. As a result, the in-vehicle air conditioner stops.

### Fourth Activation Example

The fourth activation example is an operation example in which the in-vehicle air conditioner is activated from the slave ECU 5. Since the slave ECU 5 is always supplied with power even when the vehicle is stopped, it can wake up by detecting the input of a signal indicating that the activation switch connected to the slave ECU 5 is turned on even during sleep.

When the slave ECU 5 wakes up and confirms an input to be activated regarding the in-vehicle air conditioner, it generates an NM frame with the bit corresponding to the second cluster turned on. The slave ECU 5 transmits the generated NM frame via the CAN communication section 82. When the master ECU 2 receives this NM frame, the master ECU 2 turns the relays 504 and 505 belonging to the second cluster on.

When the activation switch of the in-vehicle air conditioner is turned off, the slave ECU 5 stops transmitting the NM frame and transitions to the sleep state after a while. When the NM frame is interrupted, the master ECU 2 turns the relays 504 and 505 off after a while and terminates the control.

If the master ECU 2 determines that it is necessary to continue the control even after the NM frame transmission is stopped, the master ECU 2 transmits an NM frame with the bit corresponding to the second cluster turned on. As a result, the slave ECU 5, the smart sensor 501, and the smart actuator 502 can maintain activation until the transmission of the NM frame generated by the master ECU 2 is stopped.

(Power Shutdown Process Extension) The NM-equipped nodes are powered without passing through a relay and can execute termination processing to transition to a low power consumption state independently. However, the NM-non-equipped nodes cannot perform termination processing if the power supply is suddenly cut off by turning off the relay. Termination processing includes, for example, saving operation logs, saving diagnostic data, saving learning results, and setting input/output devices to the initial position for the next activation.

The communication system 1 of the third embodiment can perform the following first, second, third, and fourth measures to secure time for termination processing.

### (First Measure)

The master ECU 2, which controls the relays 26, 27, 504, and 505, notifies the subordinate nodes (that is, the slave ECUs 3, 4, 5, the smart sensor 501, and the smart actuator 502) of a relay-off pre-notification message via the CAN communication sections 22, 23, and 24 before executing the relay-off. The master ECU 2 also stops transmitting non-emergency CAN communications. The pre-notification message may have a predetermined CAN ID and data pattern.

The master ECU 2 manages the time required for the termination processing of the subordinate nodes (that is, the slave ECUs 3, 4, 5, the smart sensor 501, and the smart actuator 502). After transmitting the above pre-notification message, the master ECU 2 measures the elapsed time and turns the relays 26, 27, 504, and 505 off when the required termination processing time is exceeded. The NM-non-equipped nodes stop communication, execute termination processing, and wait for the power supply to be cut off upon receiving the relay-off pre-notification message.

### (Second Measure)

The master ECU 2 notifies the subordinate nodes (that is, the slave ECUs 3, 4, 5, the smart sensor 501, and the smart actuator 502) of a relay-off pre-notification message via the CAN communication sections 22, 23, and 24 before executing the relay-off. The master ECU 2 also stops transmitting non-emergency CAN communications. The pre-notification message may have a predetermined CAN ID and data pattern.

The master ECU 2 manages the time required for the termination processing of the subordinate nodes (that is, the slave ECUs 3, 4, 5, the smart sensor 501, and the smart actuator 502) for each node. After transmitting the above pre-notification message, the master ECU 2 measures the elapsed time and sequentially turns off the relays corresponding to the nodes when the required termination processing time is exceeded. The NM-non-equipped nodes stop communication, execute termination processing, and wait for the power supply to be cut off upon receiving the relay-off pre-notification message.

### (Third Measure)

The master ECU 2 and the NM-equipped nodes can synchronize the sleep timing by mutually transmitting and receiving NM frames.

When the sleep condition is satisfied with the end of the provided service, the master ECU 2 stops communication, including NM frames. The master ECU 2 turns the relays off when the time required for the NM-non-equipped nodes to determine the interruption of the NM frames (for example, 3 seconds) and the time required for the termination processing of the NM-non-equipped nodes (for example, 2 seconds) have elapsed (for example, 5 seconds). The NM-non-equipped nodes monitor the NM frames on the communication buses 11, 12, and 13, stop transmitting from their nodes to the communication buses 11, 12, and 13 when the interruption of the NM frames is detected for a certain period (for example, 3 seconds), execute termination processing, and wait for the power supply to be cut off.

If the NM-non-equipped nodes are unlikely to complete the termination processing within the predetermined required time, they can send a predetermined command to the master ECU 2 to request an extension of the time before turning the relays off.

### (Fourth Measure)

The master ECU 2 and the NM-equipped nodes can synchronize the sleep timing by mutually transmitting and receiving NM frames.

When the sleep condition of a predetermined cluster is satisfied with the end of the provided service, the master ECU 2 sets the bits corresponding to the cluster in the NM frame to 0. After all the bits become 0 and a certain period (for example, 3 seconds) has elapsed, the master ECU 2 stops communication, including NM frames. After that, the master ECU 2 turns the relays off when the time required for the termination processing of the NM-non-equipped nodes (for example, 2 seconds) has elapsed. Here, the NM-non-equipped nodes have the function of receiving and interpreting NM frames. The NM-non-equipped nodes always monitor the NM frames transmitted by the master ECU 2 and start termination processing when all the bits of the cluster including the upstream relay supplying power to their nodes are 0. This allows the NM-non-equipped nodes to complete the termination processing before the relays supplying power to their nodes are turned off. The NM-equipped nodes sleep according to the NM frames transmitted and received with the master ECU 2.

If the NM-non-equipped nodes are unlikely to complete the termination processing within the predetermined required time, they can send a predetermined command to the master ECU 2 to request an extension of the time before turning the relays off. In this case, the master ECU 2 waits to turn the relays off while receiving the extension request from the NM-non-equipped nodes.

### Fourth Embodiment

Hereinafter, the fourth embodiment of the present disclosure will be described with reference to the drawings. In the fourth embodiment, components different from the first embodiment will be described.

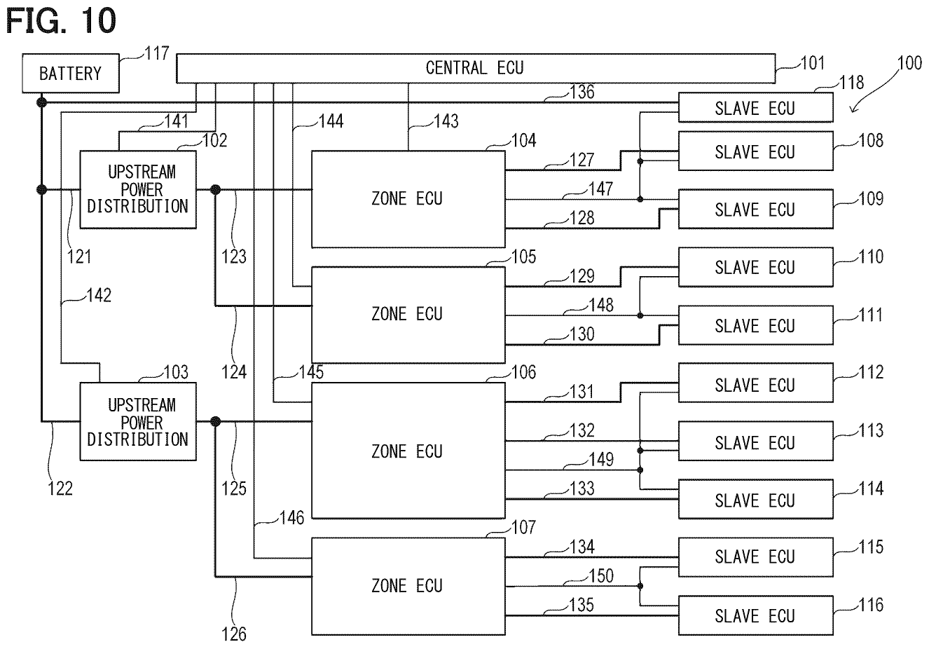

As illustrated in FIG. 10, the communication system 100 of the fourth embodiment includes a central ECU 101, upstream power distribution sections 102 and 103, zone ECUs 104, 105, 106, and 107, slave ECUs 108, 109, 110, 111, 112, 113, 114, 115, 116, and 118, and a battery 117. Hereinafter, the central ECU 101, the zone ECUs 104 to 107, and the slave ECUs 108 to 116 and 118 are collectively referred to as nodes.

The battery 117 supplies power to each section of the vehicle with a direct-current battery voltage (for example, 12 V). The central ECU 101, the upstream power distribution sections 102 and 103, the zone ECUs 104 to 107, and the slave ECUs 108 to 116 and 118 operate by receiving a power supply from the battery 117.

The upstream power distribution section 102 receives a power supply from the battery 117 via a power supply path 121 between the battery 117 and the upstream power distribution section 102. The upstream power distribution section 103 receives a power supply from the battery 117 via a power supply path 122 between the battery 117 and the upstream power distribution section 103.

The zone ECUs 104 and 105 each receive a power supply from the battery 117 via power supply paths 123 and 124 between the upstream power distribution section 102 and the zone ECUs 104 and 105, respectively.

The zone ECUs 106 and 107 each receive a power supply from the battery 117 via power supply paths 125 and 126 between the upstream power distribution section 103 and the zone ECUs 106 and 107, respectively.

The slave ECUs 108 and 109 each receive a power supply from the battery 117 via power supply paths 127 and 128 between the zone ECU 104 and the slave ECUs 108 and 109, respectively.

The slave ECUs 110 and 111 each receive a power supply from the battery 117 via power supply paths 129 and 130 between the zone ECU 105 and the slave ECUs 110 and 111, respectively.

The slave ECUs 112, 113, and 114 each receive a power supply from the battery 117 via power supply paths 131, 132, and 133 between the zone ECU 106 and the slave ECUs 112, 113, and 114, respectively.

The slave ECUs 115 and 116 each receive a power supply from the battery 117 via power supply paths 134 and 135 between the zone ECU 107 and the slave ECUs 115 and 116, respectively.

The slave ECU 118 receives a power supply from the battery 117 via a power supply path 136. The central ECU 101 and the upstream power distribution section 102 are data-communicably connected to each other via a communication line 141.

The central ECU 101 and the upstream power distribution section 103 are data-communicably connected to each other via a communication line 142. The central ECU 101 and the zone ECUs 104, 105, 106, and 107 are data-communicably connected to each other via communication lines 143, 144, 145, and 146, respectively.

The zone ECU 104 and the slave ECUs 108, 109, and 118 are data-communicably connected to each other via a communication bus 147. The zone ECU 105 and the slave ECUs 110 and 111 are data-communicably connected to each other via a communication bus 148.

The zone ECU 106 and the slave ECUs 112, 113, and 114 are data-communicably connected to each other via a communication bus 149. The zone ECU 107 and the slave ECUs 115 and 116 are data-communicably connected to each other via a communication bus 150.

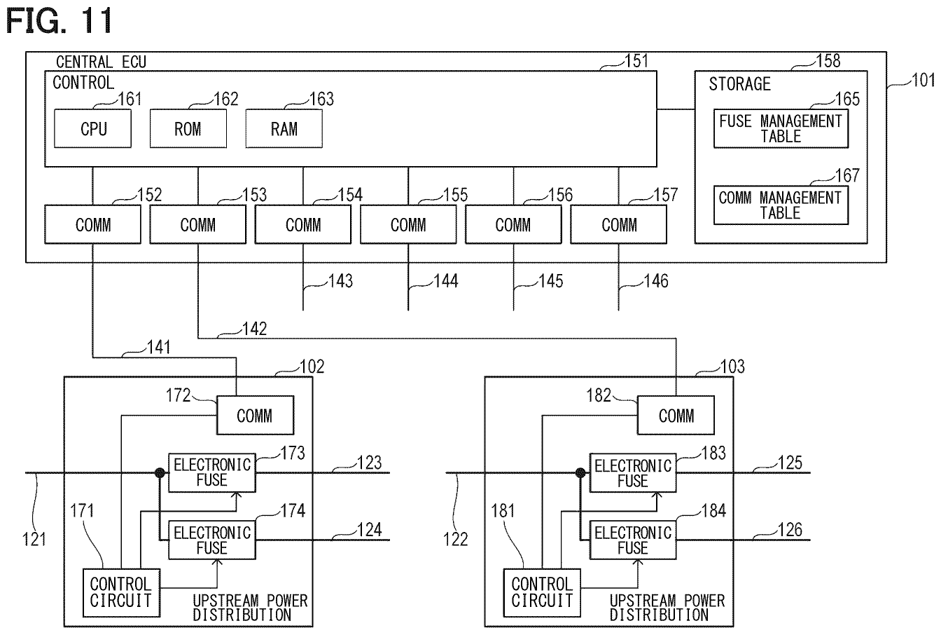

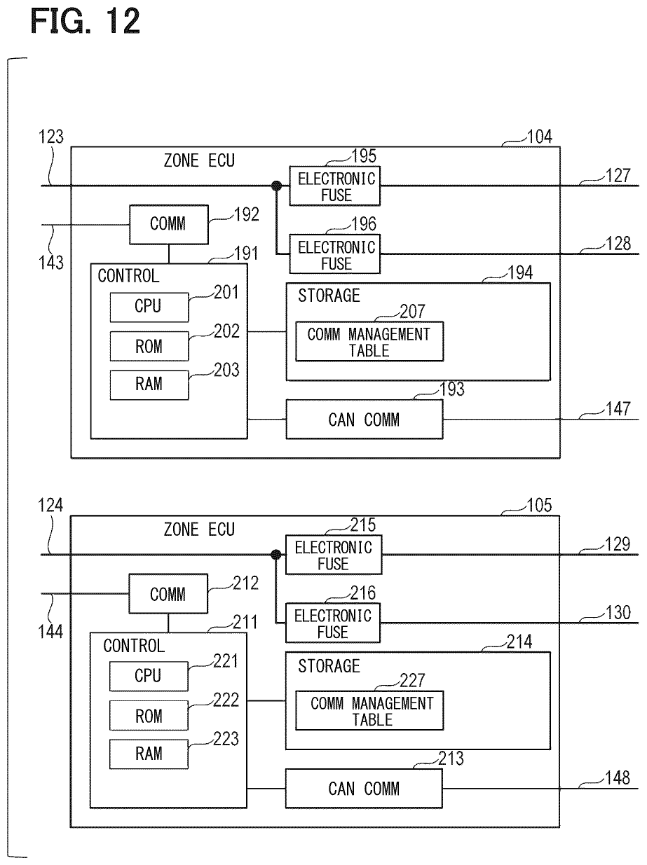

As illustrated in FIG. 11, the central ECU 101 includes a control section 151, communication sections 152, 153, 154, 155, 156, and 157, and a storage section 158. The control section 151 is an electronic control device mainly including a microcomputer including a CPU 161, a ROM 162, a RAM 163, and the like. Various functions of the microcomputer are implemented by the CPU 161 executing a program stored in a non-transitory tangible recording medium. In this example, the ROM 162 corresponds to a non-transitory tangible recording medium storing a program. Further, by executing this program, a method corresponding to the program is executed. Some or all of the functions executed by the CPU 161 may be configured as hardware by one or a plurality of ICs or the like. Furthermore, the number of microcomputers constituting the control section 151 may be one or more.

The communication section 152 performs communication with the upstream power distribution section 102 connected to the communication line 141 by transmitting and receiving a communication frame based on, for example, the Ethernet communication protocol. Ethernet is a registered trademark.

The communication section 153 performs communication with the upstream power distribution section 103 connected to the communication line 142 by transmitting and receiving a communication frame based on, for example, the Ethernet communication protocol. The communication section 154 performs communication with the zone ECU 104 connected to the communication line 143 by transmitting and receiving a communication frame based on, for example, the Ethernet communication protocol.

The communication section 155 performs communication with the zone ECU 105 connected to the communication line 144 by transmitting and receiving a communication frame based on, for example, the Ethernet communication protocol. The communication section 156 performs communication with the zone ECU 106 connected to the communication line 145 by transmitting and receiving a communication frame based on, for example, the Ethernet communication protocol.

The communication section 157 performs communication with the zone ECU 107 connected to the communication line 146 by transmitting and receiving a communication frame based on, for example, the Ethernet communication protocol. The storage section 158 is a storage device for storing various pieces of data. The storage section 158 stores a fuse management table 165 and a communication management table 167 to be described later.

The upstream power distribution section 102 includes a control circuit 171, a communication section 172, and electronic fuses 173 and 174. The control circuit 171 controls switching the electronic fuses 173 and 174 between the on state and the off state based on instructions obtained from the central ECU 101 via the communication section 172.

The communication section 172 performs communication with the central ECU 101 connected to the communication line 141 by transmitting and receiving a communication frame based on, for example, the Ethernet communication protocol.

The electronic fuse 173 is disposed between the power supply path 121 and the power supply path 123. The electronic fuse 174 is disposed between the power supply path 121 and the power supply path 124. The upstream power distribution section 103 includes a control circuit 181, a communication section 182, and electronic fuses 183 and 184.

The control circuit 181 controls switching the electronic fuses 183 and 184 between the on state and the off state based on instructions obtained from the central ECU 101 via the communication section 182.

The communication section 182 performs communication with the central ECU 101 connected to the communication line 142 by transmitting and receiving a communication frame based on, for example, the Ethernet communication protocol.

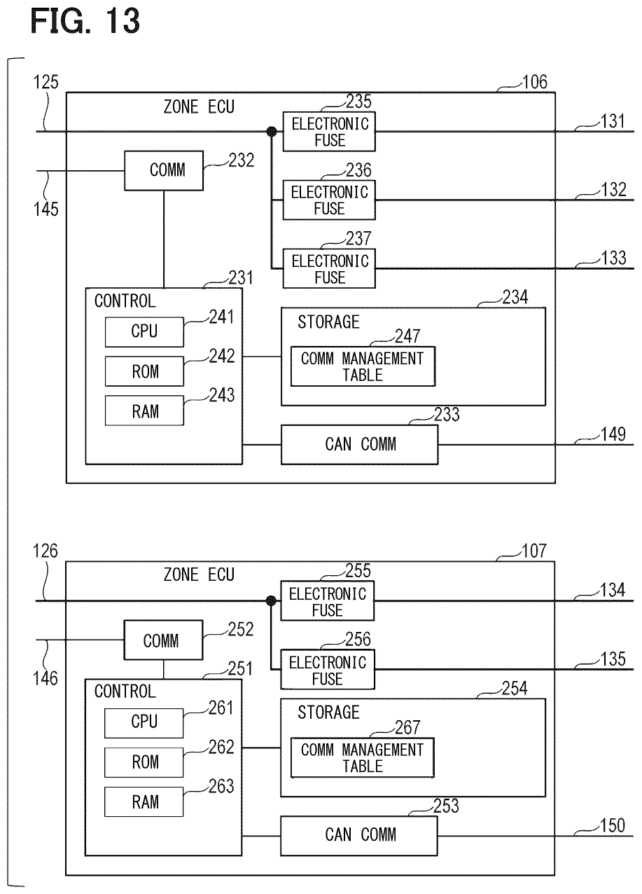

The electronic fuse 183 is disposed between the power supply path 122 and the power supply path 125. The electronic fuse 184 is disposed between the power supply path 122 and the power supply path 126. As illustrated in FIG. 12, the zone ECU 104 includes a control section 191, a communication section 192, a CAN communication section 193, a storage section 194, and electronic fuses 195 and 196.

The control section 191 is an electronic control device mainly including a microcomputer including a CPU 201, a ROM 202, a RAM 203, and the like. Various functions of the microcomputer are implemented by the CPU 201 executing a program stored in a non-transitory tangible recording medium. In this example, the ROM 202 corresponds to a non-transitory tangible recording medium storing a program. Further, by executing this program, a method corresponding to the program is executed. Some or all of the functions executed by the CPU 201 may be configured as hardware by one or a plurality of ICs or the like. Furthermore, the number of microcomputers constituting the control section 191 may be one or more.

The communication section 192 performs communication with the central ECU 101 connected to the communication line 143 by transmitting and receiving a communication frame based on, for example, the Ethernet communication protocol.

The CAN communication section 193 performs communication with the slave ECUs 108 and 109 connected to the communication bus 147 by transmitting and receiving a communication frame based on the CAN communication protocol.

The storage section 194 is a storage device for storing various pieces of data. The storage section 194 stores a communication management table 207 to be described later. The electronic fuse 195 is disposed between the power supply path 123 and the power supply path 127. The electronic fuse 196 is disposed between the power supply path 123 and the power supply path 128.

The zone ECU 105 includes a control section 211, a communication section 212, a CAN communication section 213, a storage section 214, and electronic fuses 215 and 216. The control section 211 is an electronic control device mainly including a microcomputer including a CPU 221, a ROM 222, a RAM 223, and the like. Various functions of the microcomputer are implemented by the CPU 221 executing a program stored in a non-transitory tangible recording medium. In this example, the ROM 222 corresponds to a non-transitory tangible recording medium storing a program. Further, by executing this program, a method corresponding to the program is executed. Some or all of the functions executed by the CPU 221 may be configured as hardware by one or a plurality of ICs or the like. Furthermore, the number of microcomputers constituting the control section 211 may be one or more.

The communication section 212 performs communication with the central ECU 101 connected to the communication line 144 by transmitting and receiving a communication frame based on, for example, the Ethernet communication protocol.

The CAN communication section 213 performs communication with the slave ECUs 110 and 111 connected to the communication bus 148 by transmitting and receiving a communication frame based on the CAN communication protocol.

The storage section 214 is a storage device for storing various pieces of data. The storage section 214 stores a communication management table 227 to be described later. The electronic fuse 215 is disposed between the power supply path 124 and the power supply path 129. The electronic fuse 216 is disposed between the power supply path 124 and the power supply path 130.

As illustrated in FIG. 13, the zone ECU 106 includes a control section 231, a communication section 232, a CAN communication section 233, a storage section 234, and electronic fuses 235, 236, and 237. The control section 231 is an electronic control device mainly including a microcomputer including a CPU 241, a ROM 242, a RAM 243, and the like. Various functions of the microcomputer are implemented by the CPU 241 executing a program stored in a non-transitory tangible recording medium. In this example, the ROM 242 corresponds to a non-transitory tangible recording medium storing a program. Further, by executing this program, a method corresponding to the program is executed. Some or all of the functions executed by the CPU 241 may be configured as hardware by one or a plurality of ICs or the like. Furthermore, the number of microcomputers constituting the control section 231 may be one or more.

The communication section 232 performs communication with the central ECU 101 connected to the communication line 145 by transmitting and receiving a communication frame based on, for example, the Ethernet communication protocol.

The CAN communication section 233 performs communication with the slave ECUs 112, 113, and 114 connected to the communication bus 149 by transmitting and receiving a communication frame based on the CAN communication protocol.

The storage section 234 is a storage device for storing various pieces of data. The storage section 234 stores a communication management table 247 to be described later. The electronic fuse 235 is disposed between the power supply path 125 and the power supply path 131. The electronic fuse 236 is disposed between the power supply path 125 and the power supply path 132. The electronic fuse 237 is disposed between the power supply path 125 and the power supply path 133.

The zone ECU 107 includes a control section 251, a communication section 252, a CAN communication section 253, a storage section 254, and electronic fuses 255 and 256. The control section 251 is an electronic control device mainly including a microcomputer including a CPU 261, a ROM 262, a RAM 263, and the like. Various functions of the microcomputer are implemented by the CPU 261 executing a program stored in a non-transitory tangible recording medium. In this example, the ROM 262 corresponds to a non-transitory tangible recording medium storing a program. Further, by executing this program, a method corresponding to the program is executed. Some or all of the functions executed by the CPU 261 may be configured as hardware by one or a plurality of ICs or the like. Furthermore, the number of microcomputers constituting the control section 251 may be one or more.

The communication section 252 performs communication with the central ECU 101 connected to the communication line 146 by transmitting and receiving a communication frame based on, for example, the Ethernet communication protocol.

The CAN communication section 253 performs communication with the slave ECUs 115 and 116 connected to the communication bus 150 by transmitting and receiving a communication frame based on the CAN communication protocol.

The storage section 254 is a storage device for storing various pieces of data. The storage section 254 stores a communication management table 267 to be described later. The electronic fuse 255 is disposed between the power supply path 126 and the power supply path 134. The electronic fuse 256 is disposed between the power supply path 126 and the power supply path 135.

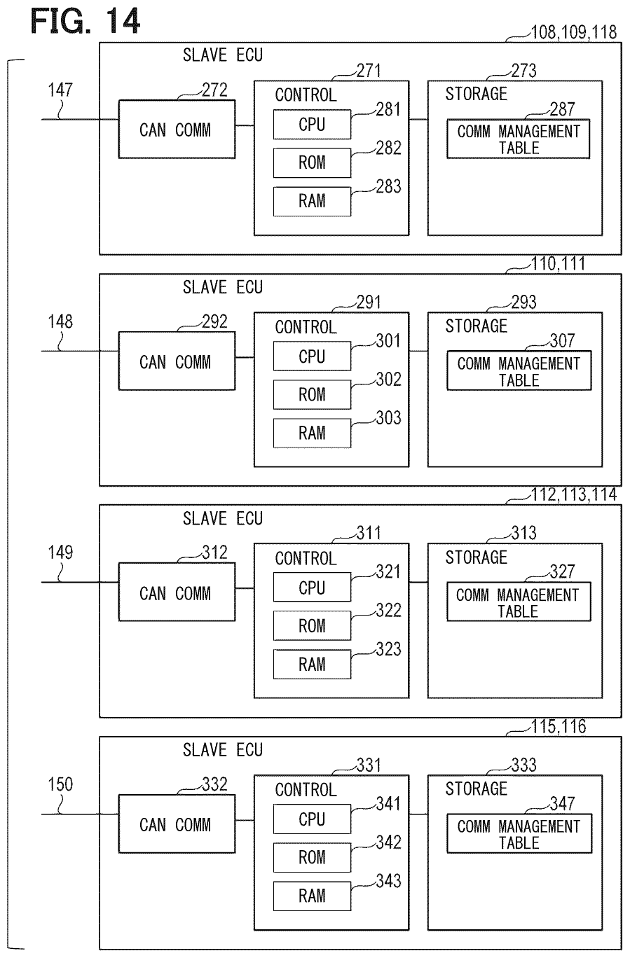

As illustrated in FIG. 14, the slave ECUs 108, 109, and 118 include a control section 271, a CAN communication section 272, and a storage section 273. The control section 271 is an electronic control device mainly including a microcomputer including a CPU 281, a ROM 282, a RAM 283, and the like. Various functions of the microcomputer are implemented by the CPU 281 executing a program stored in a non-transitory tangible recording medium. In this example, the ROM 282 corresponds to a non-transitory tangible recording medium storing a program. Further, by executing this program, a method corresponding to the program is executed. Some or all of the functions executed by the CPU 281 may be configured as hardware by one or a plurality of ICs or the like. Furthermore, the number of microcomputers constituting the control section 271 may be one or more.

The CAN communication section 272 performs communication with the zone ECU 104 connected to the communication bus 147 by transmitting and receiving a communication frame based on the CAN communication protocol. The storage section 273 is a storage device for storing various pieces of data. The storage section 273 stores a communication management table 287 to be described

The slave ECUs 110 and 111 include a control section 291, a CAN communication section 292, and a storage section 293. The control section 291 is an electronic control device mainly including a microcomputer including a CPU 301, a ROM 302, a RAM 303, and the like. Various functions of the microcomputer are implemented by the CPU 301 executing a program stored in a non-transitory tangible recording medium. In this example, the ROM 302 corresponds to a non-transitory tangible recording medium storing a program. Further, by executing this program, a method corresponding to the program is executed. Some or all of the functions executed by the CPU 301 may be configured as hardware by one or a plurality of ICs or the like. Furthermore, the number of microcomputers constituting the control section 291 may be one or more.

The CAN communication section 292 performs communication with the zone ECU 105 connected to the communication bus 148 by transmitting and receiving a communication frame based on the CAN communication protocol. The storage section 293 is a storage device for storing various pieces of data. The storage section 293 stores a communication management table 307 to be described later.

The slave ECUs 112, 113, and 114 include a control section 311, a CAN communication section 312, and a storage section 313. The control section 311 is an electronic control device mainly including a microcomputer including a CPU 321, a ROM 322, a RAM 323, and the like. Various functions of the microcomputer are implemented by the CPU 321 executing a program stored in a non-transitory tangible recording medium. In this example, the ROM 322 corresponds to a non-transitory tangible recording medium storing a program. Further, by executing this program, a method corresponding to the program is executed. Some or all of the functions executed by the CPU 321 may be configured as hardware by one or a plurality of ICs or the like. Furthermore, the number of microcomputers constituting the control section 311 may be one or more.

The CAN communication section 312 performs communication with the zone ECU 106 connected to the communication bus 149 by transmitting and receiving a communication frame based on the CAN communication protocol. The storage section 313 is a storage device for storing various pieces of data. The storage section 313 stores a communication management table 327 to be described later.

The slave ECUs 115 and 116 include a control section 331, a CAN communication section 332, and a storage section 333. The control section 331 is an electronic control device mainly including a microcomputer including a CPU 341, a ROM 342, a RAM 343, and the like. Various functions of the microcomputer are implemented by the CPU 341 executing a program stored in a non-transitory tangible recording medium. In this example, the ROM 342 corresponds to a non-transitory tangible recording medium storing a program. Further, by executing this program, a method corresponding to the program is executed. Some or all of the functions executed by the CPU 341 may be configured as hardware by one or a plurality of ICs or the like. Furthermore, the number of microcomputers constituting the control section 331 may be one or more.

The CAN communication section 332 performs communication with the zone ECU 107 connected to the communication bus 150 by transmitting and receiving a communication frame based on the CAN communication protocol. The storage section 333 is a storage device for storing various pieces of data. The storage section 333 stores a communication management table 347 to be described later.

The fuse management table 165 sets a correspondence relationship between switching information, and a control target and a mounting destination for each of a plurality of pieces of switching information included in an NM frame. The communication management tables 167, 207, 227, 247, 267, 287, 307, 327, and 347 set a correspondence relationship between a service, switching information, and activation information for each of a plurality of services provided to an occupant of a vehicle using the central ECU 101, the zone ECUs 104 to 107, and the slave ECUs 108 to 116 and 118.

The switching information indicates whether to turn the electronic fuses 173, 174, 183, 184, 195, 196, 215, 216, 235, 236, 237, 255, and 256 on or off. The activation information indicates whether to bring the slave ECU 118 into the wake-up state.

Note that the communication management tables 167, 207, 227, 247, 267, 287, 307, 327, and 347 do not necessarily store switching information and activation information for services that the subject device cannot detect the establishment of the service start condition.

Therefore, when detecting that a service start condition is satisfied, the central ECU 101, the zone ECUs 104 to 107, and the slave ECUs 108 to 116 and 118 extract switching information and activation information corresponding to the corresponding service from the communication management tables 167, 207, 227, 247, 267, 287, 307, 327, and 347, and generate and transmit an NM frame including the extracted switching information and activation information.

When the CPU 161 of the control section 151 of the central ECU 101 receives an NM frame (S10), it transmits an electronic fuse on/off request to the zone ECUs 104 to 107 based on the switching information included in the received NM frame and the fuse management table 165 (S20), and also transmits an electronic fuse on/off request to the upstream power distribution sections 102 and 103 (S30).

Specifically, the CPU 161 first refers to the fuse management table 165 to identify the bit and the control target where the zone ECUs 104 to 107 are mounting destinations. Further, the CPU 161 identifies whether to turn the control target electronic fuse on based on the switching information of the identified bit in the received NM frame. Then, the CPU 161 transmits an electronic fuse on/off request indicating whether to turn the identified control target on to the identified mounting destination (that is, the zone ECUs 104 to 107).

The CPU 161 also refers to the fuse management table 165 to identify the bit and the control target where the upstream power distribution sections 102 and 103 are mounting destinations. Further, the CPU 161 identifies whether to turn the control target electronic fuse on based on the switching information of the identified bit in the received NM frame. Then, the CPU 161 transmits an electronic fuse on/off request indicating whether to turn the identified control target on to the identified mounting destination (that is, the upstream power distribution sections 102 and 103).

The upstream power distribution sections 102 and 103 and the zone ECUs 104 to 107 turn the subordinate electronic fuses on or off based on the received electronic fuse on/off request.

The communication system 100 configured as described above includes the slave ECU 108, the zone ECU 104, the central ECU 101, and the upstream power distribution section 102. The slave ECU 108 receives a power supply from the battery 117 via the electronic fuse 195 configured to switch between a conduction state (hereinafter, the first conduction state) in which the power supply path 127 is conducted and a cutoff state (hereinafter, the first cutoff state) in which the power supply path 127 is cut off.

The zone ECU 104 is configured to receive a power supply from the battery 117 via the electronic fuse 173 configured to switch between a conduction state (hereinafter, the second conduction state) in which the power supply path 123 is conducted and a cutoff state (hereinafter, the second cutoff state) in which the power supply path 123 is cut off, and control the operation of the electronic fuse 195.

The central ECU 101 and the upstream power distribution section 102 are configured to control the operation of the electronic fuse 173. The central ECU 101 is configured to transmit an electronic fuse on/off request for requesting whether to bring the electronic fuse 195 into the first conduction state to the zone ECU 104 based on switching information (hereinafter, first switching information) indicating whether to bring the electronic fuse 195 into the first conduction state and switching information (hereinafter, second switching information) indicating whether to bring the electronic fuse 173 into the second conduction state included in an NM frame. The zone ECU 104, which has received the electronic fuse on/off request, brings the electronic fuse 195 into either the first conduction state or the first cutoff state according to the request.

The central ECU 101 and the upstream power distribution section 102 are configured to bring the electronic fuse 173 into either the second conduction state or the second cutoff state based on the NM frame. In such a communication system 100, the central ECU 101 and the upstream power distribution section 102 can bring the electronic fuse 173 into either the second conduction state or the second cutoff state based on the second switching information included in the NM frame. Specifically, the upstream power distribution section 102 brings the electronic fuse 173 into either the second conduction state or the second cutoff state based on the electronic fuse on/off request transmitted by the central ECU 101.

Further, in the communication system 100, the zone ECU 104 receives the electronic fuse on/off request transmitted from the central ECU 101 based on the first switching information included in the NM frame. Based on this electronic fuse on/off request, the zone ECU 104 can bring the electronic fuse 195 into either the first conduction state or the first cutoff state. Therefore, the communication system 100 can individually control the power supply to the zone ECU 104 connected to the central ECU 101 and the power supply to the slave ECU 108 connected to the zone ECU 104, and can individually manage the activation of the plurality of zone ECUs 104 and slave ECUs 108.

In the embodiment described above, the power supply path 127 corresponds to a first power supply path, the electronic fuse 195 corresponds to a first power supply switching section, the battery 117 corresponds to a power source, and the slave ECU 108 corresponds to a slave control device.

The power supply path 123 corresponds to a second power supply path, the electronic fuse 173 corresponds to a second power supply switching section, the zone ECU 104 corresponds to a first power supply switching control section, and the central ECU 101 and the upstream power distribution section 102 correspond to a second power supply switching control section and a power supply switching device.

The fuse management table 165 corresponds to a switching section management table, and the electronic fuse on/off request corresponds to first switching instruction information and a first switching request.

### Fifth Embodiment

Hereinafter, the fifth embodiment of the present disclosure will be described. In the fifth embodiment, components different from the fourth embodiment will be described.

The communication system 100 of the fifth embodiment is different from that of the fourth embodiment in that not only the central ECU 101 but also the zone ECUs 104 to 107 store the fuse management table 165. The central ECU 101 of the fifth embodiment executes the same processing as the master power supply management process of the second embodiment.

That is, when the CPU 161 of the control section 151 of the central ECU 101 receives an NM frame (S210), it identifies the zone ECUs 104, 105, 106, and 107 connected to the electronic fuses 173, 174, 183, and 184 to be turned off as transmission prohibition ECUs based on the switching information included in the received NM frame and the fuse management table 165 (S220).

The CPU 161 identifies the zone ECUs 104, 105, 106, and 107 connected to the electronic fuses 173, 174, 183, and 184 that switch from the off state to the on state as transmission standby ECUs based on the switching information included in the received NM frame, the switching information included in the NM frame received last time, and the fuse management table 165 (S230).

The CPU 161 identifies, as the normal transmission ECU, an ECU that is not identified as the transmission prohibition ECU and is not identified as the transmission standby ECU, among the zone ECUs 104 to 107 (S240).

Then, the CPU 161 transmits the received NM frame to the normal transmission ECU (S250). The CPU 161 also transmits an electronic fuse on/off request to the upstream power distribution sections 102 and 103 to turn the electronic fuses connected to the transmission prohibition ECU off and to turn the electronic fuses connected to the transmission standby ECU on (S260).

When the transmission standby ECU is activated (S270), the CPU 161 transmits the received NM frame to the transmission standby ECU (S280). Although an embodiment of the present disclosure has been described above, the present disclosure is not limited to the above embodiment and can be implemented in various modifications.

The control sections 21, 41, and 61 and their methods described in the present disclosure may be implemented by a dedicated computer provided by configuring a processor and a memory programmed to execute one or more functions embodied by a computer program. Alternatively, the control sections 21, 41, and 61 and their methods described in the present disclosure may be implemented by a dedicated computer provided by configuring a processor with one or more dedicated hardware logic circuits. Alternatively, the control sections 21, 41, and 61 and their methods described in the present disclosure may be implemented by one or more dedicated computers configured by a combination of a processor and a memory programmed to execute one or more functions and one or more hardware logic circuits. The computer program may be stored in a computer-readable non-transitory tangible recording medium as instructions executed by a computer. The method for realizing the functions of each part included in the control sections 21, 41, and 61 does not necessarily include software, and all the functions may be realized using one or more hardware.

The multiple functions possessed by one component in the above embodiment may be realized by multiple components, or one function possessed by one component may be realized by multiple components. Also, multiple functions possessed by multiple components may be realized by one component, or one function realized by multiple components may be realized by one component. Further, some of the configurations of the above embodiment may be omitted. Also, at least some of the configurations of the above embodiment may be added to or replaced with the configurations of other embodiments.

In addition to the ECUs 2 to 4, 101, and 104 to 116 described above, the present disclosure can also be realized in various forms such as a system including the ECUs 2 to 4, 101, and 104 to 116 as components, a program for causing a computer to function as the ECUs 2 to 4, 101, and 104 to 116, a non-transitory tangible recording medium such as a semiconductor memory storing the program, and a communication management method.

What is claimed is:

1. A communication system comprising:
a slave control device that receives a power supply from a power source via a first power supply switching section configured to switch between a first conduction state in which a first power supply path is conducted and a first cutoff state in which the first power supply path is cut off;
a first power supply switching control section configured to receive a power supply from the power source via a second power supply switching section configured to switch between a second conduction state in which a second power supply path is conducted and a second cutoff state in which the second power supply path is cut off, and control an operation of the first power supply switching section;
a second power supply switching control section configured to control an operation of the second power supply switching section;
a switching transmission section configured to transmit, based on a management frame that is a communication frame including first switching information indicating whether to bring the first power supply switching section into the first conduction state and second switching information indicating whether to bring the second power supply switching section into the second conduction state, first switching instruction information indicating whether to bring the first power supply switching section into the first conduction state to the first power supply switching control section; and
a power supply control section configured to bring the second power supply switching section into either the second conduction state or the second cutoff state based on the management frame.

2. The communication system according to claim 1, further comprising:
a switching section management table in which first mounting destination information indicating a control device on which the first power supply switching section is mounted and second mounting destination information indicating a control device on which the second power supply switching section is mounted are set,
wherein
the switching transmission section is configured to transmit, upon receiving the management frame, a first switching request for requesting whether to bring the first power supply switching section into the first conduction state to the first power supply switching control section as the first switching instruction information based on the first mounting destination information of the switching section management table and the first switching information.

3. The communication system according to claim 2, wherein
the first power supply path is connected to the power source via the second power supply path, and
the switching transmission section is configured to prohibit transmission of the first switching request in a case where the second switching information included in the management frame indicates the second cutoff state.

4. The communication system according to claim 1, wherein
the switching transmission section is configured to transmit the management frame to the first power supply switching control section as the first switching instruction information upon receiving the management frame, and
the first power supply switching control section is configured to bring the first power supply switching section into either the first conduction state or the first cutoff state based on the first switching information included in the management frame upon receiving the management frame.

5. The communication system according to claim 4, wherein
the first power supply path is connected to the power source via the second power supply path, and
the switching transmission section is configured to prohibit transmission of the management frame in a case where the second switching information included in the management frame indicates the second cutoff state.

6. The communication system according to claim 4, wherein
in a case where the second power supply switching section is in the second cutoff state and the second switching information included in the management frame indicates the second conduction state, the switching transmission section is configured to transmit the management frame after the second power supply switching section is in the second conduction state and the first power supply switching control section is activated.

7. The communication system according to claim 1, wherein
the communication system includes:
the slave control device;
a zone control device that is data-communicably connected to the slave control device and includes the first power supply switching section;
an upstream power distribution section including the second power supply switching section; and
a central control device that is data-communicably connected to the zone control device and the upstream power distribution section,
wherein
the central control device and the upstream power distribution section include the second power supply switching control section, the switching transmission section, and the power supply control section.

8. A power supply switching device in a communication system including a slave control device that receives a power supply from a power source via a first power supply switching section configured to switch between a first conduction state in which a first power supply path is conducted and a first cutoff state in which the first power supply path is cut off and a power supply switching control section configured to receive a power supply from the power source via a second power supply switching section configured to switch between a second conduction state in which a second power supply path is conducted and a second cutoff state in which the second power supply path is cut off, and control an operation of the first power supply switching section, the power supply switching device being configured to control an operation of the second power supply switching section, the power supply switching device comprising:
a switching transmission section configured to transmit, based on a management frame that is a communication frame including first switching information indicating whether to bring the first power supply switching section into the first conduction state and second switching information indicating whether to bring the second power supply switching section into the second conduction state, first switching instruction information indicating whether to bring the first power supply switching section into the first conduction state to the power supply switching control section; and
a power supply control section configured to bring the second power supply switching section into either the second conduction state or the second cutoff state based on the management frame.
